(19) United States
(12) Patent Application Publication
(10) Pub. No.: US 2023/0341149 A1
(43) Pub. Date: Oct. 26, 2023

(54) COMPRESSIBLE ELECTRIC HEATER

(71) Applicant: Türk & Hillinger GmbH, Tuttlingen (DE)

(72) Inventors: Andreas SCHLIPF, Tuttlingen (DE); Kamen GEORGIEV, Villingen-Schwenningen (DE)

(73) Assignee: Türk & Hillinger GmbH, Tuttlingen (DE)

(21) Appl. No.: 18/137,244

(22) Filed: Apr. 20, 2023

(30) Foreign Application Priority Data
Apr. 25, 2022 (DE) 20 2022 102 213.5

(51) Int. Cl. F24H 9/1818; H05B 3/58; H05B 3/18

(52) U.S. Cl. CPC F24H 9/1818; H05B 3/18; H05B 3/58

(57) ABSTRACT

An electric heater with an axial opening for holding an object to be heated includes an electric heating element and a clamping sleeve for generating an adjustable, radial force acting in a direction toward a center axis of the axial opening. The clamping sleeve of the electric heater is cut through by a groove whose width can be changed by a clamping device. The clamping device has a pin that is perpendicular to the center axis of the axial opening and is connected to the clamping sleeve on a first side of the groove. The clamping device further has a washer that is arranged on the pin and is supported in a radial direction of the washer on a bearing that is connected to the clamping sleeve on a second side of the groove such that when the washer is rotated, a position of the pin is shifted in space.

### CROSS-REFERENCE TO RELATED APPLICATIONS

This application claims priority under 35 U.S.C. § 119(b) to German Patent Application No. 20 2022 102 213.5, filed on Apr. 25, 2022, the disclosure of which is incorporated herein by reference in its entirety.

### BACKGROUND OF THE INVENTION

The preferred invention relates to an electric heater with the characteristics of the device described herein.

Heaters with an electric heating element pushed onto a body to be heated and fastened there by clamping are known from the prior art. For example, such heaters are used in injection molding machines or in hot runner and distributor systems as nozzle heaters for heating nozzle bodies.

From the state of the art available on the market, it is already known to provide a one-piece clamping sleeve around the heating element in direct contact or, e.g., if this is embedded between an inner and an outer metal sleeve, in indirect contact. When viewed in the radial direction, this clamping sleeve has overlapping sections between which a screw-operated wedge mechanism is arranged. If you turn the screw in one direction, the wedge mechanism is moved in such a way that its height changes, which results in an increase in the distance between the overlapping sections of the clamping sleeve, which, because of the essentially constant length of the clamping sleeve, leads to a tightening of the heater on the body to be heated. Turning the screw in the other direction makes it possible to loosen the clamping sleeve again.

The problem with this heater with a clamping sleeve is the increased space requirement of the clamping mechanism in the radial direction due to the wedge mechanism, because in many cases, especially with hot runner nozzles, the individual nozzles to be heated are arranged in blocks and between the nozzle and the block there is only one relatively narrow tubular channel into which the heater must fit.

Especially for applications in which such an increased space requirement cannot be satisfied, heating devices have been developed, such as those that are disclosed, for example, in DE 200 15 016 U1 or DE 20 2011 003 451 U1. In these heaters, the heating element is arranged between an inner and an outer metal sleeve and the heater has a slit that cuts through it in the axial direction. Furthermore, compression elements are provided, which interact with the outer metal sleeve in such a way that their displacement in the axial direction changes the width of the slit in the circumferential direction, thereby producing the fastening to the body to be heated. This interaction is realized by guide elements that are guided in guides running at an angle to the slit.

A problem with these heaters is the operation of the compression elements, which in many cases must be accomplished, for example, when the heater is pushed open, within a narrow, tubular channel that is only accessible from one side. For example, it can be difficult to release a compression element again.

Therefore, there are further developments already known from EP 3 895 872 A1, in which a rotational movement is used to move guide elements in guides whose distance from the axis of rotation varies in order to influence the width of the slit.

In practice, it has been shown that the use of guide elements and guides involves high production costs and limits the mechanical stability of the clamping devices.

### BRIEF SUMMARY OF THE INVENTION

The task of the preferred invention is therefore to provide a compressible electric heater that is easy to manufacture and is stable and easy to operate. This task is achieved by a heater having the features of the preferred electric heater. Further advantageous developments of the invention are the subject matter of the dependent claims.

The electric heater according to the preferred invention has an axial opening for holding an object to be heated, whose outer contour can preferably be cylindrical. An electric heating element, preferably surrounding the axial opening at least in sections and a clamping sleeve, preferably in the shape of a cylinder jacket or a truncated cone jacket, to produce an adjustable force acting radially in the direction of a center axis of the axial opening.

The following explanations should contribute to an even clearer understanding of this distinct terminology:

The geometry of such a heater can preferably be described using terms from the geometry of the cylinder or the generalized cylinder and cylinder coordinates. The direction of the cylinder axis is specified by the center axis, which defines the axial opening of the heater into which the object to be heated is usually inserted, and is referred to below as the axial direction.

A force acts radially in the direction of this center axis when it acts on a connecting line perpendicular to this center axis between a point on the cylinder jacket and a point on the center axis in the direction of the center axis and is therefore particularly suitable for pressing the electric heater against an object to be heated arranged in its axial opening.

The profile of an electric heating element in space can be described in particular in these cylinder coordinates, i.e., by the position on the center axis of the axial opening, the distance in the radial direction from the center axis of the axial opening, and a polar angle between zero degrees (0°) and three hundred sixty degrees (360°). The electric heating element surrounds the axial opening at least in sections when there are different polar angles for describing the profile of the electric heating element in the area of the axial opening. In particular, this is the case when the side of the electric heating element facing the axial opening lies on an imaginary cylinder or truncated cone surface that encloses the axial opening, preferably coaxially, which in turn is particularly the case when the electric heating element is coiled or meandering on an imaginary cylinder or truncated cone, the pitch can vary in the direction parallel to the cylinder or truncated cone axis.

It should be noted, in particular, that the clamping sleeve in various embodiments of electric heaters according to the invention can be implemented on one hand as a separate, additional component, but on the other hand also by different components of the electric heater itself.

For example, the clamping sleeve in electric heaters, in which the electric heating element is embedded in a powder or granulate with good thermal conductivity, which fills the interior space between a tubular inner sleeve designed as a slot and a tubular outer sleeve usually arranged concentrically thereto with a groove that can be designed as a slit, which are connected to one another by lateral boundary surfaces at the edges of the grooves or the slits, are formed by the tubular outer sleeve with the groove or the slit.

In embodiments in which a coiled electric heating element in the form of a coiled tube cartridge is surrounded by a tubular outer sleeve with a groove, preferably in the form of a slit, against which it forms a direct contact, this can also form the clamping sleeve.

And in embodiments in which a coiled tube cartridge is inserted into a groove made in a metal surface, wherein the metal surface is a surface of a metal body that is preferably in the form of, in particular, a slotted tube, wherein this shape can be realized, for example, from one piece by rolling up a metal plate before or after inserting the coiled tube cartridge, this metal body can form the clamping sleeve.

According to the preferred invention, at least the clamping sleeve of the electric heater is groove, at least in some sections, by a groove that can be designed, in particular, as a slit. A groove is therefore to be understood in particular as an opening, cut, or through-hole; groups of openings, cuts, or through-holes are also conceivable. The groove passes through the clamping sleeve at least in some sections and therefore does not necessarily have to extend over its entire length.

The width of the groove or in particular of the slit, which can be understood as the distance of opposite edge points of the groove essentially perpendicular to the axis of the axial opening, must be changeable by means of at least one clamping device.

An alternative description of the condition that the width of the groove can be changed by means of the clamping device can be made using a description of the groove in cylindrical coordinates: at each point on the cylinder axis at which there is a groove, it covers a specific polar angle range. If the polar angle range covered by the groove varies with a different position of the clamping device at such points on the cylinder axis, the width of the gap can be changed by means of the clamping device.

It is preferred for the invention that the clamping device has a pin that is perpendicular to the center axis of the axial opening and is connected to the clamping sleeve on one side of the groove, either directly or indirectly via another component, and that the clamping device also has a washer arranged on this pin, typically aligned perpendicular to the pin, which is in a radial direction of the washer with its edge or with a projection that is connected to the washer and preferably formed on it supported on a bearing so that it is connected to the clamping sleeve on the other side of the groove, such that, when the washer rotates, the position of the pin is shifted in space.

In this way, a clamping mechanism is also provided that can be operated via a rotational movement and can have a very flat construction. At the same time, however, the mechanical stability of the components of the clamping mechanism is noticeably increased because the washer and the pin can be designed to be significantly more massive than the guide elements and guides of the clamping devices from the prior art.

A particularly simple way of realizing the displacement of the pin in space provides that the washer is eccentric or has an eccentric projection. Due to this shape, when the washer rotates, the distance changes between the point through which the pin runs and the contact surface between the edge of the washer or its projection on one side and the associated bearing on the other side.

In order to initiate the rotational movement, it is particularly advantageous if the clamping device has a tool mount that is on the axis of rotation of the washer. This can be, for example, a contact for a screwdriver or an Allen wrench, or a contact surface for a ring wrench.

The space required for an electric heater with such a clamping mechanism is particularly minimal if the clamping sleeve has a recess in which the clamping device is arranged at least in sections.

It is preferred if a bearing which supports the washer in a radial direction extends into and/or beyond the groove starting from the side of the groove where it is fastened.

It is also preferred if the pin, which is perpendicular to the center axis of the axial opening, is connected to one side of the groove by one of its ends being mounted in an arm that is connected to this side of the groove and extends into the groove.

The clamping device can have a particularly flat construction if the bearing that supports the washer in a radial direction has a mount or guide for the arm. In particular, it can then be realized that the bottom side of the bearing, which supports the washer in a radial direction, and the bottom side of the arm lie in one plane. This has advantages when it comes to manufacturing because the clamping mechanism largely does not need to be adapted to the diameter of the electric heater.

If a heat-insulating layer is arranged between the clamping sleeve and the electric heating element in the compressible electric heater, a change in the position of the electric heater relative to the object to be heated can also be effectively counteracted by performing a large number of heating cycles.

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1 is a side perspective view of a first embodiment of an electric heater with clamping mechanism;

FIG. 2a is a side perspective, exploded view of the clamping mechanism from FIG. 1;

FIG. 2b is a side elevational view of the clamping mechanism from FIG. 2a, viewed along the direction of extension of the center axis;

FIG. 2c is a cross-sectional view taken through the clamping mechanism from FIG. 2a;

FIG. 2d is a bottom perspective view of a bottom side of the clamping mechanism from FIG. 2a in the relaxed state;

FIG. 2e is a bottom perspective view of the bottom side of the clamping mechanism from FIG. 2a in the compressed state;

FIG. 3 is a bottom perspective view of the washer of the clamping mechanism from FIG. 2a, viewed from its bottom side;

FIG. 4 is a bottom perspective view of the bearing of the clamping mechanism from FIG. 2a that is part of the washer from FIG. 3;

FIG. 5 is a side perspective view of a second embodiment of an electric heater with clamping mechanism;

FIG. 6a is a side perspective, exploded-view of the clamping mechanism from FIG. 5;

FIG. 6b is a side elevational view of the clamping mechanism from FIG. 6a, viewed along the direction of extension of the center axis; and

FIG. 6c is a cross-sectional view of the clamping mechanism of FIG. 6a taken through the clamping mechanism from FIG. 6a.

### DETAILED DESCRIPTION OF THE INVENTION

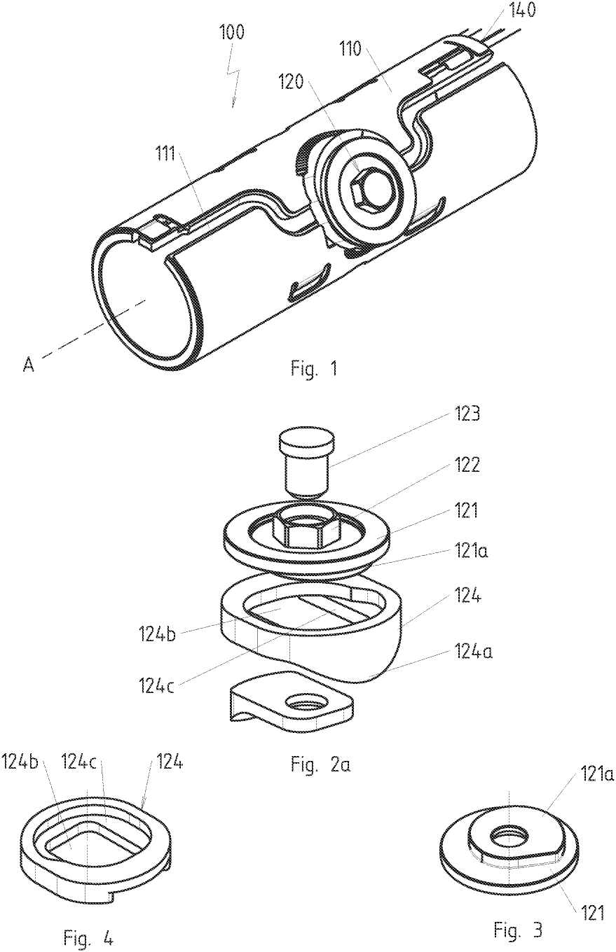

FIG. 1 shows an external view of a first electric heater 100 with a clamping device 120. The connection lines that supply the electric heater 100 with power are provided with the reference symbol 140.

The electric heater 100 essentially has the shape of a hollow cylinder with a slit that cuts through the hollow cylinder along its direction of extension defined by the cylinder axis forming the center axis A of the axial opening of the hollow cylinder and that forms the groove 111. The electric heater 100 has a clamping sleeve 110 that also forms the outer sleeve of the hollow cylinder, which is connected to the inner sleeve of the hollow cylinder via lateral boundary surfaces of the slit forming the groove 111 and boundary surfaces on the cover and base. In the interior space defined by these lateral or boundary surfaces, the electric heating element not visible in FIG. 1 is arranged embedded in a similarly not visible powder or granule material that has good heat-conducting properties, in particular, magnesium oxide and is electrically insulated from the lateral or boundary surfaces.

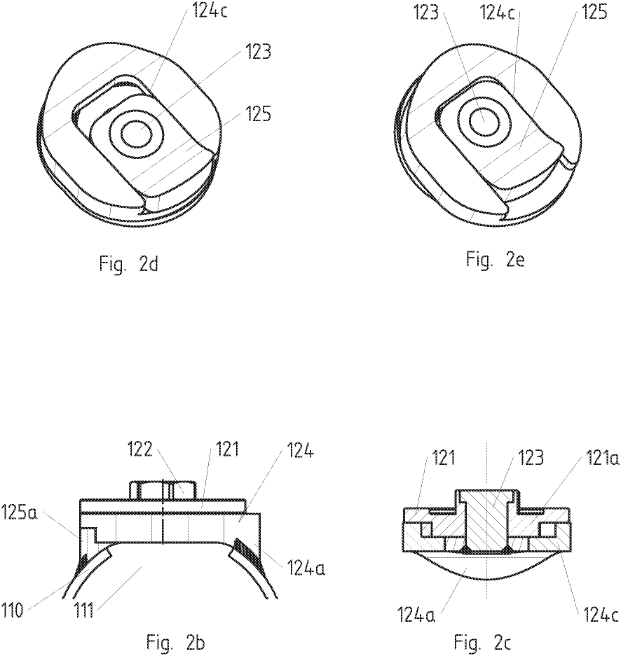

The clamping device 120, whose structure and functioning can be seen especially well in FIGS. 2a to 2e, has a washer 121, on whose top side there is a tool mount 122, which is here designed as a contact surface for a wrench, and is mounted so that it can rotate about the pin 123 standing perpendicular to the center axis A.

One end of the pin 123 is mounted on an arm 125, with which the pin 123 is rigidly connected by means of welding or soldering in this embodiment, as shown in FIG. 2c. On its side, the arm 125 has a fastening section 125a, with which it is connected to the clamping sleeve 110, in particular, welded rigidly to it. In this way, the pin 123 is connected to the clamping sleeve 110 on one side of the groove.

As can be seen especially well in FIG. 3, the washer 121 has an eccentrically shaped projection 121a on the side opposite the tool mount 122, so that the distance of the edge of the projection from the pin 123 varies in different radial directions.

The clamping device 120 further has a bearing 124 that is connected to the clamping sleeve 110 with a fastening section 124a, in particular, welded rigidly to it. The bearing 124 has a bearing opening 124b, in which the projection 121a of the washer 121 engages, so that it is supported on a side wall of the bearing opening 124b. In principle, an eccentrically shaped washer can also be used, which is arranged in the bearing opening 124b and is supported on a side wall of the bearing opening 124b, preferably in a direction parallel to the direct line connecting the sides of the groove 111.

Due to the eccentric shape of the projection 121a or the washer, a rotation of the washer 121 has the effect that the distance between the side wall of the bearing opening 124b and the pin 123 changes; because the bearing 124 and the arm 125 are each fastened to different sides of the groove 111 on the clamping sleeve 110, the width b of the groove 111 changes accordingly.

At this point it should be noted that two configurations are possible that depend on whether the washers 121 or their projection 121a are supported on the side wall of the bearing opening on the side of the groove 111 on which the bearing 124 is fastened or on the wall opposite this.

If, in the first case, this distance increases, the pin 123 is pressed against the compression force of the clamping sleeve 110, which has the effect, because its bottom end is pushed away by means of the arm 125 with the clamping sleeve 110 on the other side of the groove 111 than the side of the groove on which the bearing 124 is fastened, and the groove 111 becomes wider. If the distance decreases, the force of the clamping sleeve 110 has the effect that the groove 111 or its width b becomes smaller. In this case, the contact force that presses the electric heater 100 onto the object to be heated is provided by compression of the clamping sleeve; for the electric heater 100 to be moved away, this force must be overcome by widening the clamping sleeve against its force.

In the second case, however, if the distance increases between the pin 123 and the side wall of the bearing opening 124b on which the washers 121 or the projection 121a are supported, the width of the groove 111 decreases, because the arm 125 and thus the side of the clamping sleeve 110, on which it is fastened, is pushed against the compression force of the clamping sleeve in the direction toward the opposite side of the groove 111, on which the bearing 124 is fastened. If this distance decreases, the force again causes a widening of the opening.

The movement of the pin 123 and the arm 125 connected to it relative to the bearing 124, which is realized in both cases by the rotation of the washers 121, can be seen especially well in the illustration of FIGS. 2d and 2e.

In this embodiment, the bearing 124 also has a guide 124c that can be seen especially well in FIGS. 2c, 2d, and 2e and holds the arm 125 - preferably completely.

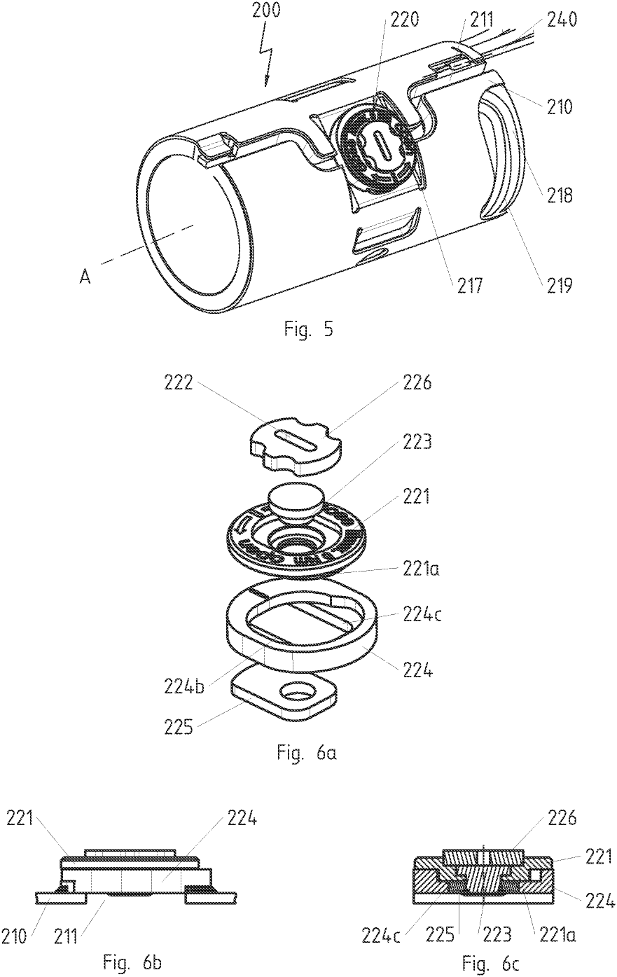

FIG. 5 shows a view of a second electric heater 200 with center axis A, a clamping sleeve 210, a groove 211 realized as a slit, and a clamping device 220. A groove 219 is formed in the clamping sleeve 210, in which an electric helical tube cartridge is inserted as electric heating element 218.

In this case, the clamping device 220 with washer 221, tool mount 222, pin 223, bearing 224 with bearing opening 224b and guide 224c, as well as arm 225 is arranged in a recess 217 with a flat bottom in the clamping sleeve 210. Accordingly, the bearing 224 and the arm 225 also have no fastening sections, as can be seen in FIGS. 6a to 6c, but instead they contact and are fastened directly with sections of its bottom side to the base of the recess 217. As can be seen from FIG. 6a, the basic structure and interaction of the clamping device 220 is the same as that of the clamping device 120. The only other difference is that the tool mount 222 is constructed here as a recess in a plate 226, which is connected rotationally locked with the washer 221.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

List of reference symbols

| | |
|---|---|
| 100,200 | Electric heater |
| 111,211 | groove |
| 110,210 | clamping sleeve |
| 120,220 | clamping device |
| 121,221 | Washer |
| 121a,221a | Projection |
| 122,222 | Tool mount |
| 123,223 | Pin |
| 124,224 | Bearing |
| 124 a | Fastening section |
| 124b,224b | Bearing opening |
| 124c,224c | Guide |
| 125,225 | Arm |
| 125 a | Fastening section |
| 217 | Recess |
| 218 | Electric heating element |
| 219 | Groove |
| 226 | Plate |
| A | Center axis |
| b | Width |

1. An electric heater with an axial opening for holding an object to be heated, the electric heater comprising:
an electric heating element;
a clamping sleeve for generating an adjustable, radial force acting ina direction toward a center axis of the axial opening, wherein the clamping sleeve is cut through by a groove whose width can be changed by a clamping device,
the clamping device has a pin that is perpendicular to the center axis of the axial opening and is connected to the clamping sleeve on a first side of the groove and that the clamping device further has a washer that is arranged on the pin and is supported in a radial direction of the washer on a bearing that is connected to the clamping sleeve on a second side of the groove such that when the washer is rotated, a position of the pin is shifted in space.

2. The electric heater according to claim 1, wherein the washer is eccentric or has an eccentric projection .

3. The electric heater according to claim 1, wherein the clamping device has a tool mount located on an axis of rotation of the washer.

4. The electric heater according to claim 1, wherein the clamping sleeve has a recess in which the clamping device is arranged at least in some sections.

5. The electric heater according to claim 1, wherein the bearing that supports the washer in a radial direction extends into the groove starting from the first side of the groove .

6. The electric heater according to claim 1, wherein the pin that is perpendicular to the center axis of the axial opening is connected to the first side of the groove, an end of the pin is supported in an arm that is connected to the first side of the groove and extends into the groove.

7. The electric heater according to claim 6, wherein the bearing that supports the washer in the radial direction has a mount or guide for the arm.

8. The electric heater according to claim 7, wherein a bottom side of the bearing that supports the washer in the radial direction and a bottom side of the arm are located in a plane.

9. The electric heater according to claim 1, wherein a heat-insulating layer is arranged between the clamping sleeve and the electric heating element.
